(19) United States
(12) Patent Application Publication
(10) Pub. No.: US 2017/0013060 A1
(43) Pub. Date: Jan. 12, 2017

(54) COMMUNICATION IN A HETEROGENEOUS DISTRIBUTED SYSTEM

(71) Applicant: HEWLETT PACKARD ENTERPRISE DEVELOPMENT LP, Houston, TX (US)

(72) Inventors: Jichuan Chang, Palo Alto, CA (US); Sheng Li, Palo Alto, CA (US); Michael R. Krause, Boulder Creek, CA (US)

(73) Assignee: Hewlett Packard Enterprise Development LP, Houston, TX (US)

(21) Appl. No.: 15/113,976

(22) PCT Filed: Jan. 31, 2014
(86) PCT No.: PCT/US2014/014068

§ 371 Date: Jul. 25, 2016

(51) Int. Cl. H04L 29/08

(52) U.S. Cl. CPC H04L 67/1097; H04L 61/6022

(57) ABSTRACT

Methods and systems for communication in a heterogeneous distributed system are described. The described systems implement the described methods, where the method includes receiving data from at least one data source, by a data store computing device. The method further includes identifying a data source from amongst the at least one data source to have generated the data, based on host parameters associated with the data source and the data. Further, the method includes determining the data to be represented in a first data presentation based on the identified data source and the host parameters and transforming the data from the first data presentation to a second data presentation, where the data store computing device operates using the second data presentation.

### BACKGROUND

In the rapidly-evolving competitive marketplace, data is among an organization's most valuable assets. Meeting day-to-day business requisites of organizations depends on access to data and information, and the ability to quickly and seamlessly distribute data throughout the members of the organization. Organizations may extract, refine, manipulate, transform, integrate and distribute data in formats suitable for strategic decision-making.

In heterogeneous environments, where data is housed on disparate platforms in any number of different formats and used in many different contexts it may be challenging to communicate data.

### BRIEF DESCRIPTION OF DRAWINGS

The detailed description is provided with reference to the accompanying figures. In the figures, the left-most digit(s) of a reference number identifies the figure in which the reference number first appears. The same numbers are used throughout the drawings to reference like features and components.

FIG. 1(a) illustrates an example a distributed heterogeneous system, implementing a data store computing device;

FIG. 1(b) illustrates another example distributed heterogeneous system, implementing a data source computing device;

FIG. 2 is a flowchart representative of an example method of communication in a distributed heterogeneous system;

FIG. 3 illustrates an example distributed heterogeneous system, implementing a non-transitory computer-readable medium for a data store computing device.

### DETAILED DESCRIPTION

The present subject matter relates to systems and methods for communication in a heterogeneous distributed system. In recent years, organizations have seen substantial growth in data volume. Since organizations continuously collect large datasets that record information, such as customer interactions information, product sales information, and results from advertising campaigns on the Internet, many organizations today are facing tremendous challenges in managing the growing data volume. Consequently, storage and analysis of large volumes of data has emerged as a concern for many organizations, both big and small, across all industries.

For such requisites of organizations, although the use of a single high-performance computer is possible in principle, but such an approach may utilize tremendously large processing time and sophisticated hardware components. Therefore, to achieve storage and analysis of large volumes of data within an acceptable time, distributed systems which provide parallel storage and processing techniques are employed.

The use of distributed systems for storage and analysis of data is beneficial for practical reasons. For example, it may be more cost-efficient to obtain a desired level of performance by using a cluster of several low-end computing devices, in comparison with a single high-end computing device. Further, the use of duster of computing devices of a distributed system may also provide enhanced speed of processing and reliable data storage capabilities as compared with a single computing device. Therefore, more and more organizations are utilizing interlinked computing devices which form a distributed system for storage and analysis of data.

The duster of computing devices in the distributed system generally communicates over a network with each other and other computing devices of the distributed system to provide various functionalities. In the distributed system, some computing devices are also communicatively coupled to data stores to process data within the data stores. For the purpose of explanation, the computing devices communicatively coupled with the data stores have been referred to as data store computing devices, hereinafter. As used herein, ‘communicatively coupled’ may mean a direct connection between entities in consideration to exchange data signals with each other via an electrical signal, electromagnetic signal, optical signal, etc. For example, entities that may be either directly communicatively connected with and/or collocated in/on a same device (e.g., a computer, a server, etc.) and communicatively connected to one another have been referred to be communicatively coupled with each other, hereinafter. Therefore, computing devices directly communicatively coupled and/or collocated with the data stores are referred to as data store computing devices.

Further, for the sake of clarity, as used herein, the computing devices communicating with the data store computing devices have been referred to as host computing devices, hereinafter. As used herein, ‘communicating with’ may mean either a communication via a network or an indirect communication link (e.g., a communication link including an intermediate communication device, such as a router, another entity, etc.) between entities in consideration. For example, entities that may be either communicating via a network, or through an indirect communication link have been referred to be communicating with each other, hereinafter. Therefore, computing devices communicating via a network or through an indirect communication link with data store computing device are referred to as host computing devices.

The distributed system may either be a homogenous distributed system in which the computing devices or their applications operate using similar data presentations or, may be a heterogeneous distributed system in which the computing devices or their applications operate using different data presentations. As used herein, data presentations utilized by the computing devices include data format and data layout utilized for the purpose of communication. Data format may include, but is not limited to, data endianness (e.g., how bits are organized in a byte), data alignment, and data encoding. Similarly, the data layout may include, but is not limited to, row, column ordering of data, call/remote procedure call (RPC) parameter packaging format of data, and memory layout utilized for data.

In homogenous distributed systems, since the computing devices or their applications operate using similar data presentations, inclusion of computing devices and applications which operate using different data presentations is a constraint. Such a limitation restricts the type of computing devices and applications that may be utilized in the homogenous distributed systems.

In heterogeneous distributed systems, communication between the computing devices and applications operating on different data presentations is often achieved by following a set of interoperability standards that specify the common data presentation to be utilized by all computing devices. In implementation of such interoperability standards, host computing devices, while communicating with the data store computing devices, execute a set of marshalling or serialization instructions by either machine readable instructions, such as Java serialization library and protocol buffers or by hardware, such as Ethernet Network Interface Controllers (NIC) to transform host-specific presentations to the common data presentation.

However, implementation of such common data presentation among all communication devices is time and resource consuming and sacrifices efficiency and may introduce significant latency. Further, adherence to the common data presentation may introduce significant performance and energy overhead at the host computing devices. Furthermore, implementation of the common data presentation may necessitate each computing device to communicate with other computing devices and; computing devices that are unaware of the existence of the common data presentation would be rendered incapable of communicating with other computing devices of the distributed system.

According to example implementations of the present subject matter, systems and methods for communication in a heterogeneous distributed system are described. The described systems and methods may allow communication between heterogeneous computing devices which operate using different forms of data presentations. Also, with the implementation of the described systems and methods, different host computing devices may communicate with the data store computing devices in different forms of data presentation.

The described systems and methods may be implemented in various computing devices connected through various networks. Although the description herein is with reference to computing devices, communicatively coupled to data stores of distributed systems, the methods and described techniques may be implemented in other devices, albeit with a few variations. Various implementations of the present subject matter have been described below by referring to several examples.

In an example of the present subject matter, the described systems may be implemented as data store computing devices for communication with heterogeneous computing devices, such as the host computing devices. The systems and methods of the present subject matter may receive data from different computing devices and may also provide data to such computing devices, such as host computing devices.

Although it has been described that the data store computing device may communicate with different heterogeneous computing devices operating on different data presentations, however, in certain situations, different applications of a particular host computing device may also implement different data presentations. Also, certain host computing devices may also implement one or more virtual hosts which may operate using different data presentations. Therefore, in such situations, the data store computing device may receive and provide data to applications and virtual hosts. For the ease of explanation, any entity, such as the host computing device, an application of the host computing device, or a virtual host that communicates data with the data store computing device has been referred to as data source, hereinafter.

In operation, for data received at the data store computing device, a data source from which the data has originated may be identified. Based on the determination of the data source, a data presentation in which the data source operates may be determined. For instance, the identified data source may implement a first data presentation. Further, a transformation may be done for the data, from the data presentation implemented by the data source, to another data representation on which the data store computing device operates. For instance, the data may be transformed from the first data presentation to a second data presentation, where the data store computing device operates using the second data presentation.

Therefore, data received from any host computing device in any data presentation is transformed into a data presentation on which the data store operates, and subsequently processed. In one implementation, the data source from which the data originates may be identified based on one or more host parameters, which may include, but is not limited to. Media Access Control (MAC) address, Internet Protocol (IP) address, application identifier, pre-defined label, data source identifier, and data pattern.

For example, data ‘D’ received by a data store computing device, may be identified to have originated from, say, a data source A, based on host parameters, such as the MAC address of the host computing device associated with the data. Upon identification of the data source to be A, a data presentation on which the data source A operates may be determined. In the above example, the data source A may implement a data presentation ‘XYZ’ which may have a specific data format and data layout implementation. In such a situation, upon determination of the data presentation of the data source A, the data ‘G’ may be transformed into another data presentation, say data presentation ‘PQR’, implemented by the data store computing device.

In another example, the identification of the data source may be based on the IP address included in the data received by the data store computing device. Further, in other example, a data source may include a pre-defined label included in the generated data by the data source.

Further, in one implementation of the present subject matter, the data presentation on which the identified data source operates may be determined based on a pre-defined data presentation table. The pre-defined data presentation table may include the data presentation utilized by different data sources, corresponding to their one or more host parameters. For example, the data presentation table at the data store computing device may include an entry for a data source ‘A’. Such an entry for the data source ‘A’ may include one or more known hosts parameters associated with the data source ‘A’, such as MAC address, IP address, application Identifier, pre-defined label, data source Identifier, and data pattern along with the data presentation utilized by the data source ‘A’. Based on such an entry for the data source ‘A’ in the data presentation table, the data presentation on which the data source ‘A’ operates may be identified by the data store computing device.

In another implementation, the data store computing device may identify a data source to have generated the data, and the data presentation on which the data source operates is based on a data pattern associated with the data received. That is, the data received by the data store computing device may be analyzed and patterns, such as data structures and value patterns may be determined. Based on the determined patterns, the data source to have generated the data, and the data presentation of the data are identified. Therefore, in situations where a pre-defined label is not included in the data by the data sources, data presentation of the data may still be identified based on the data pattern.

Upon determination of the data presentation of the received data, the data store computing device may transform the data into the data presentation implemented by the data store computing device. In one implementation, such a transformation may be based on a transformation table which may define a procedure of transformation of the data from one data presentation to the other, or may include pointers to the procedures of transformation of the data from one data presentation to the other. For example, if the data received is identified to be in a first data presentation based on the host parameters and the data presentation table, the transformation table may allow the data store computing device to select a procedure for transformation of the data to a second data presentation on which the data store computing device operated.

In another implementation of the present subject matter, the data store computing device may also provide data to a different data source implementing different data presentations. In such a situation, the data store computing device may transform the data to be provided to the data source from one data presentation to another. The data store computing device may utilize the data presentation table and the transformation table to determine the data presentation of the data source and the procedure of transformation of data. For example, the data store computing device implementing a second data presentation may convert data into a third data presentation to provide the data to a data source implementing the third data presentation.

The above described method of transformation of the data presentation from one to another at the data store computing device may allow different heterogeneous data sources to communicate with data store computing devices without implementing any common data presentation. Further, since in the described implementation of the present subject matter the data sources do not transform data from one data presentation to another, performance and energy overheads are not encountered by the data sources. Furthermore, since the transformation of data is performed by the data store computing device, the host computing devices may be unaware of any occurrence of data transformation and may communicate data without initiating any specific transformation request.

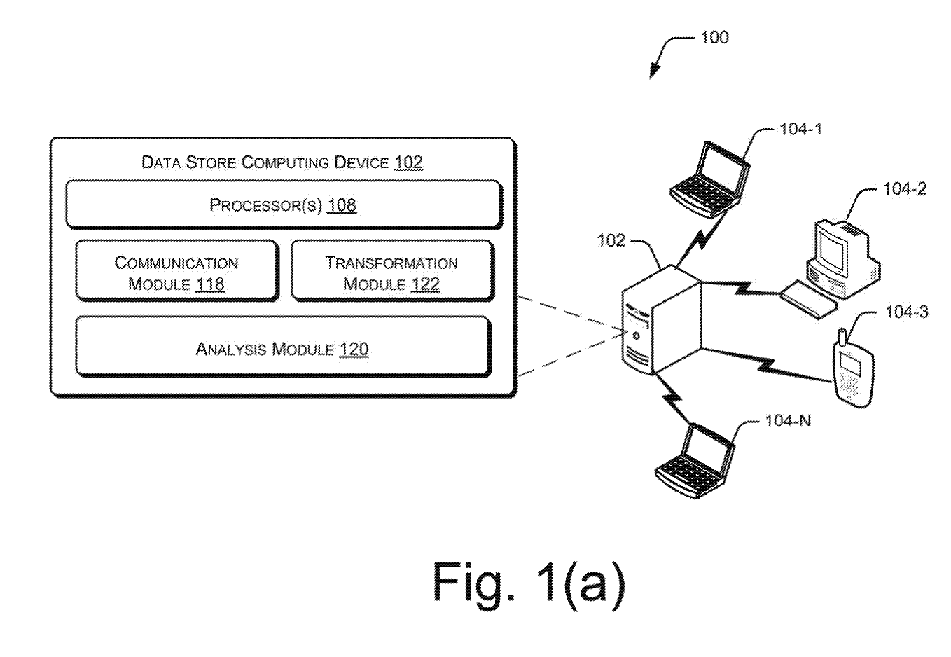

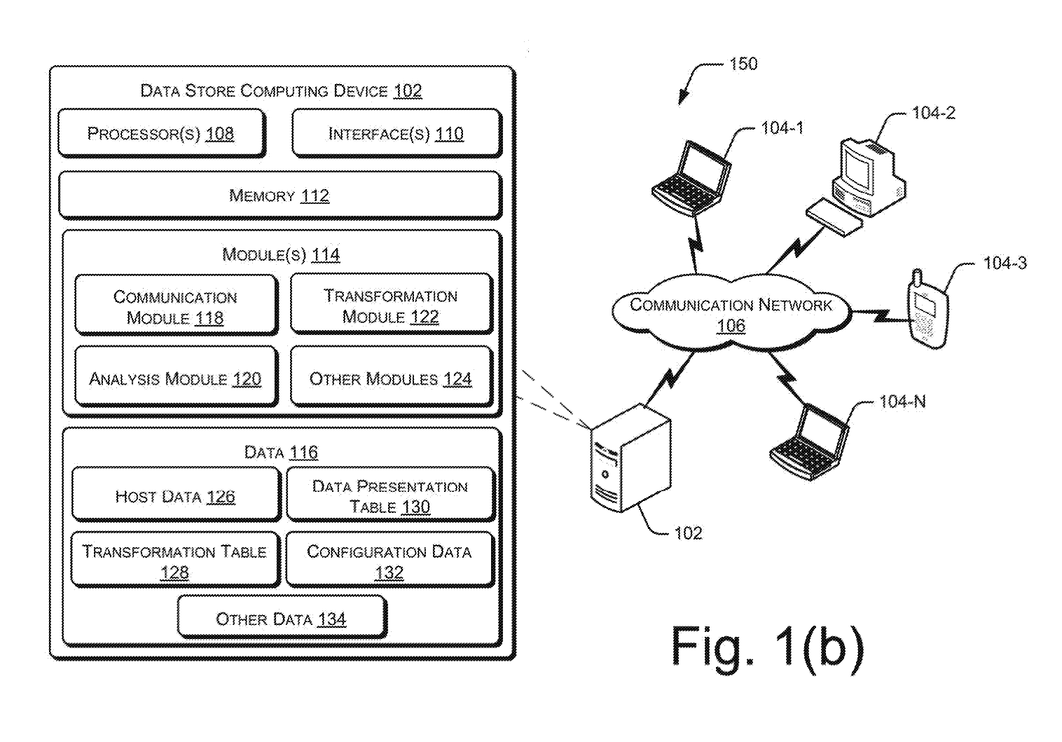

The above systems and methods are further described with reference to FIGS. 1(a), 1(b), 2, and 3. It should be noted that the description and figures merely illustrate the principles of the present subject matter along with examples described herein and, should not be construed as a limitation to the present subject matter. It is thus understood that various arrangements may be devised that, although not explicitly described or shown herein, embody the principles of the present subject matter. Moreover, all statements herein reciting principles, aspects, and embodiments of the present subject matter, as well as specific examples thereof, are intended to encompass equivalents thereof.

FIG. 1(a) schematically illustrates a heterogeneous distributed system 100, implementing an example data store computing device (DSCD) 102, according to an example implementation of the present subject matter. The heterogeneous distributed system 100 may either be a public distributed system or may be a private distributed system. The DSCD 102 may be understood as a computing device implemented along with a data store of the heterogeneous distributed system 100. According to an implementation of the present subject matter, the DSCD 102 may be implemented as, but is not limited to, a server, a workstation, a computer, and the like. The DSCD 102 may be a machine readable instructions-based implementation or a hardware-based implementation or a combination thereof.

The DSCD 102 may communicate with different entities of the heterogeneous distributed system 100, such as different computing devices 104-1, and 104-2, 104-3, . . . , 104-N. For the purpose of explanation, the computing device 104-1, 104-2, 104-3, . . . , 104-N may include host computing devices, applications running on such host computing devices, and virtual hosts and are collectively referred to as data sources 104, and individually referred to as a data source 104. The data sources 104 may include, but are not restricted to, desktop computers, laptops, smart phones, personal digital assistants (PDAs), tablets, virtual hosts, applications, and the like. Further, the data sources 104 may operate using different data presentations where each data presentation includes a pre-defined data format and a pre-defined data layout.

In an implementation, the example DSCD 102 of FIG. 1(a) includes processor(s) 108. The processor(s) 108 may be implemented as microprocessor(s), microcomputer(s), microcontroller(s), digital signal processor(s), central processing unit(s), state machine(s), logic circuit(s), and/or any device(s) that manipulates signals based on operational instructions. Among other capabilities, the processor(s) 108 may fetch and execute computer-readable instructions stored in a memory. The functions of the various elements shown in the figure, including any functional blocks labeled as “processor(s)”, may be provided through the use of dedicated hardware as well as hardware capable of executing machine readable instructions.

In the example implementation of FIG. 1(a), the DSCD 102 includes a communication module 118, transformation module 122, and an analysis module 120. Apart from other functionalities, the communication module 118 may receive data from the data sources 104. Further the analysis module 120 may determine the data to be represented in a first data presentation based on host parameters, where the host parameters comprises either a data pattern and a value provided by the data source 104 in the data. Furthermore, the transformation module 122 may transform the data from the first data presentation to a second data presentation. In such an example implementation, the DSCD 102 may operate using the second data presentation.

Although the DSCD 102 may perform the above mentioned functionality in the described example implementation, the DSCD 102 may also perform other functionalities and may include different components. Such example functionalities and example components have been described in more detail in reference to FIG. 1(b).

FIG. 1(b) schematically illustrates a heterogeneous distributed system 150, implementing the data store computing device (DSCD) 102, according to an implementation of the present subject matter. In one implementation of the present subject matter, the DSCD 102 may be communicating with the data sources 104 through a communication network 106 through one or more communication links. The communication links between the data sources 104 and the DSCD 102 may be enabled through a desired form of communication, for example, via dial-up modem connections, cable links, digital subscriber lines (DSL), wireless or satellite links, or any other suitable form of communication.

Further, the communication network 106 may be a wireless network, a wired network, or a combination thereof. The communication network 106 may also be an individual network or a collection of many such individual networks, interconnected with each other and functioning as a single large network, e.g., the Internet or an intranet. The communication network 106 may be implemented as one of the different types of networks, such as intranet, local area network (LAN), wide area network (WAN), and such. The communication network 106 may either be a dedicated network or a shared network, which represents an association of the different types of networks that use a variety of protocols, for example, Hypertext Transfer Protocol (HTTP), Transmission Control Protocol/Internet Protocol (TCP/IP), etc., to communicate with each other.

The communication network 106 may also include individual networks, such as, but are not limited to, Global System for Communication (GSM) network, Universal Telecommunications System (UMTS) network, Long Term Evolution (LTE) network, Personal Communications Service (PCS) network, Time Division Multiple Access (TDMA) network, Code Division Multiple Access (COMA) network, Next Generation Network (NGN), Public Switched Telephone Network (PSTN), and Integrated Services Digital Network (ISDN). Depending on the implementation, the communication network 106 may include various network entities, such as base stations, gateways and routers; however, such details have been omitted to maintain the brevity of the description. Further, it may be understood that the communication between the DSCD 102, the data sources 104, and other entities may take place based on the communication protocol compatible with the communication network 106.

The DSCD 102 may also include interface(s) 110. The interface(s) 110 may include a variety of machine readable instructions-based interfaces and hardware interfaces that allow the DSCD 102 to interact with the data sources 104. Further, the interface(s) 110 may enable the DSCD 102 to communicate with other communication and computing devices, such as network entities, web servers and external repositories.

Further, the DSCD 102 includes memory 112, communicatively coupled to the processor(s) 108. The memory 112 may include any computer-readable medium including, for example, volatile memory (e.g., RAM), and/or non-volatile memory (e.g., EPROM, flash memory, Memristor, etc.).

Further, the DSCD 102 includes module(s) 114 and data 116. The module(s) 114 may be communicatively coupled to the processor(s) 108. The module(s) 114, amongst other things, include routines, programs, objects, components, data structures, and the like, which perform particular tasks or implement particular abstract data types. The module(s) 114 further include modules that supplement applications on the DSCD 102, for example, modules of an operating system. The data 116 serves, amongst other things, as a repository for storing data that may be fetched, processed, received, or generated by the module(s) 114. Although the data 116 is shown internal to the DSCD 102, it may be understood that the data 116 may reside in an external repository (not shown in the figure), which may be communicatively coupled to the DSCD 102. The DSCD 102 may communicate with the external repository through the interface(s) 110 to obtain information from the data 116.

In an implementation, the module(s) 114 of the DSCD 102 includes the communication module 118, the analysis module 120, the transformation module 122, and other module(s) 124. In an implementation, the data 116 of the DSCD 102 includes host data 126, transformation table 128, data presentation table 130, configuration data 132, and other data 134. The other module(s) 124 may include programs or coded instructions that supplement applications and functions, for example, programs in the operating system of the DSCD 102, and the other data 134 fetched, processed, received, or generated by the other module(s) 124.

The following description describes the DSCD 102 communicating in the heterogeneous distributed system 100 along with data sources 104 operating on different data presentations, in accordance with the present subject matter, and it will be understood that the concepts thereto may be extended to other computing devices of the heterogeneous distributed system 100.

In one implementation of the present subject matter, the DSCD 102 may receive and provide data and messages, commonly referred to as data, from and to the data sources 104, respectively. Since the data sources 104 operate using different data presentations, the data received from one data source 104 may be in a different data presentation as compared with that of data received from another data source 104. For example the data source 104-1 may operate using a first data presentation while the data source 104-2 may operate using a third data presentation. In such a situation, the data received by the DSCD 102 from the data source 104-1 is presented in the first data presentation, and the data received from the data source 104-2 is presented in the third data presentation.

In such an example, the DSCD 102 may either operate using any one of the data presentations of the data sources 104, the first data presentation or the third data presentation, or may operate using a different data presentation, say a second data presentation.

In one implementation of the present subject matter, the communication module 118 of the DSCD 102 may receive and/or provide data from/to the data sources 104. The communication module 118 may receive data from one or more data sources 104. The analysis module 120 of the DSCD 102 may analyze the data received to determine a corresponding data presentation of the data. To this end, the analysis module 120 may either first determine the data source 104 that generated the data based on one or more pre-defined host parameters and may determine the data presentation on which the data source 104 operates, or may directly determine the data presentation of the data based on the host parameters. The host parameters may include, but are not limited to, a MAC address, an IP address, an application identifier, a pre-defined label, a data source Identifier, and a data pattern.

Values for the host parameters may either be inherently associated with the data, such as an IP address of the data source 104, or may be included by the data source 104 in the data, such as a pre-defined label and/or data source Identifier.

As an example, the analysis module 120 may analyze the received data and determine the MAC address of the data source 104, included in the data, to be 00-14-22-01-23-45. In such an example, the analysis module 120 may identify that the data source 104-1 has generated the data based on the host data 126, where the host data 126 indicates the MAC address 00-14-22-01-23-45 is associated with the data source 104-1.

In another example, the analysis module 120 may analyze the received data and may determine the IP address of the data source 104, included in the data, to be 194.66.82.11. In such an example, the analysis module 120 may Identify that the data source 104-2 has generated the data based on the host data 126, where the host data 126 indicates the IP address 194.66.82.11 is associated with the data source 104-2.

In some examples, the analysis module 120 may not identify a specific data source 104 to have generated the data merely based on one host parameter. For example, a computing device may be running two different virtual hosts, operating on different data presentations, but may have been assigned a same IP address to be utilized at different times. Similarly, another computing device may also run different applications which operate using different data presentations, but share a same data source Identifier. Such applications may have the same data source identifier but may have separate application identifiers. Therefore, in such situations, the analysis module 120 may not determine the data source 104 merely based on one host parameters and, may instead utilize more than one host parameters to specifically identify the data source 104.

It is appreciated that for the purpose of explanation of the present subject matter, different host computing devices, different applications running on host computing devices, and different virtual hosts operating on different data presentations have been explained as different data sources 104.

Based on determination of the data source 104, the data presentation on which the identified data source 104 operates may be determined. In some examples, the analysis module 120 utilizes the data presentation table 130 of FIG. 1(b) to determine the data on which the data source 104 operates. In the above described example where the data source 104-1 was identified to have generated the data, the analysis module 120 may further utilize the data presentation table 130 to determine that the data is represented in first data presentation.

For the purpose of explanation, the data presentation table 130 may include different entries for different data sources 104. Each entry may include host parameters corresponding to a data source 104 and, a corresponding data presentation on which the data source 104 operates. Table I represents an example of the data presentation table 130.

TABLE 1

| | Host | Host | | Data |
|---|---|---|---|---|
| S. No. | Parameter 1 | Parameter 2 | Data Source | Presentation |
| 1 | IP Add. | MAC Add. | Data Source | XYZ |
| | 192.168.12.13 | 14-22-01-23-45 | 104-1 | |
| 2 | IP Add. | MAC Add. | Data Source | PQR |
| | 194.66.82.11 | A5-2E-40-34-9A | 104-2 | |
| 3 | IP Add. | MAC Add. | Data Source | FGH |
| | 194.66.82.11 | 6B-38-86-91-A5 | 104-3 | |
| \| | \| | \| | \| | \| |
| 20 | Application Id. | Data Source | Data Source | TRP |
| | AS654BHY8 | Identifier 20 | 104-20 | |

As depicted above, the host parameters for different data sources 104 may be included in the data presentation table 130, and the data presentation on which each data source 104 operates is also indicated against such host parameters. Although it has been depicted that two host parameters for each data source 104 are listed in the data presentation table 130, however, the data presentation table 130 may include more columns to represent more host parameters, or may include less columns to represent less host parameters for each data source 104. Further, although same number of host parameters are listed to be included in each entry, a different number of host parameters may also be listed for different data source 104. That is, entry for data source 104-1 may include two host parameters, while the entry for data source 104-8 may include five host parameters.

In one implementation of the present subject matter, the data sources 104 may actively include value for one or more host parameters within the data, such as value for the pre-defined label. The pre-defined label may be utilized by the analysis module 120 of the DSCD 102 to identify a particular data source 104 to have generated the data and, the data presentation of the data. The pre-defined label may include, but is not limited to, markers, tags, unique identifiers, and pointer values to define the data source 104 and the data presentation of the data source 104. For example, the pre-defined label may include a unique identifier which may be unique for each data source 104. Based on the unique Identifier of the data source 104, the analysis module 120 may utilize the data presentation table 130 to determine the data presentation of the data received.

In another example, the pre-defined label may include values that may indicate data presentation details itself. That is, the pre-defined label may provide information about the instruction set format utilized, like x86/64, an operating system of the data source 104, like Linux 2.6.22, and a compiler utilized for generation of the data, like the GCC 4.2. Therefore, based on such information in the pre-defined label, the analysis module 120 may identify the specific data source 104 to have generated the data and its data presentation.

As discussed earlier, in one implementation of the present subject matter, the DSCD 120 may directly determine the data presentation of the data received based on host parameters, without identifying the data source 104. In such an implementation, the analysis module 120 of the DSCD 102 may analyze the data packets to identify the available host parameters and may utilize the data presentation table 130 to determine the data presentation of the data received.

In certain situations where the DSCD 102 may merely have to store data received, or may have to perform an action based on the data received, the determination of the data source 104 may be avoided to efficiently utilize time and processing capabilities. Therefore, in such situations, the data presentation of the data received may be directly identified based on the host parameters.

In some examples of the present subject matter, the DSCD 102 may determine the data presentation of the data received based on a data pattern. In such examples, the analysis module 120 of the DSCD 102 may analyze value patterns and/or data structures of data received and may determine the data presentation based on the analyzed value patterns and/or data structures. For example, an array of structures with integer 1 and a pre-defined string may be identified by the analysis module 120 to be represented in a particular data presentation. Similarly, an array of structures with integer 0 and another pre-defined string may be identified by the analysis module 120 to be represented in another data presentation.

Upon determination of the data presentation of the data received, the data received may further be transformed to another data presentation, such as the data presentation in which the DSCD 102 operates. In one implementation of the present subject matter, the transformation module 122 may transform the data received from one data presentation to another based on the transformation table 128.

The transformation module 122 of FIG. 1(b) may determine either a procedure or a pointer to such procedure of transformation of the data received based on the transformation table 128. The procedure of transformation may be understood as a method to be performed or a function/instructions to be executed for the transformation of the data from one data presentation to another. The transformation table 128, similar to the data presentation table 130, may include entries corresponding to the data presentations and corresponding procedure of transformation. The below depicted table, table 2, depicts an example of the transformation table 128.

TABLE 2

| | Data Presentation | Data Presentation | Procedure For |
|---|---|---|---|
| S. No. | Input | Output | Transformation/pointer |
| 1 | XYZ | ABC | Function 1 |
| 2 | PQR | SWD | Function 2 |
| 3 | FGH | ABC | Pointer to Function 3 |
| \| | \| | \| | \| |
| N | TRP | DYQ | Function N |

As depicted in the above table 2, the procedure to be adopted by the transformation module 122, for transforming the data from one presentation to another may be listed in the transformation table 128.

In an example, if the analysis module 120 identifies that the data presentation of the data received is ‘FGH’, the transformation module 128 may determine the data presentation in which the data is to be transformed is ‘ABC’. In such a scenario, the transformation module 122 may utilize the transformation table 128 to identify entry 3 where, for the transformation of data presentation ‘FGH’ to data presentation ‘ABC’, a corresponding ‘Function 3’ is listed. Therefore, the transformation module 122 may execute the ‘Function 3’ and transform the data received from the data presentation ‘FGH’ to data presentation ‘ABC’ and generate a transformed data. The transformed data may be utilized by the DSCD 102 for further processing.

Although the transformation table 128 is shown to have been implemented separately from the data presentation table 130, in one implementation, the data 116 of the DSCD 102 may include a combined table to represent data presentation associated with data sources 104 and, procedure to transform data received from such data presentation to another. Such table may either be implemented either as a relational table, or a look up tables (LUT), depending upon the implementation of the present subject matter.

As described above, while communicating with data sources 104, apart from receiving data, the DSCD 102 may also provide data to the data sources 104, and the data sources 104 operate using different data presentations. For the purpose of explanation, the data to be provided by the DSCD 102 is defined as second data. According to an implementation of the present subject matter, the DSCD 102 may provide the second data to the data source 104 in a data presentation on which the data source 104 operates. For example, if the DSCD 102 operates using the second data presentation, such as ‘ABC’ and the data source 104-2 to which the second data is to be provided operates using third data presentation, such as ‘PQR’, the DSCD 102 may transform the second data from the second data presentation ‘ABC’ to the third data presentation ‘PQR’, and provide the transformed second data to the data source 104-2.

The communication module 118 of the DSCD 102 may also update the data 116, such that the data presentation table 130, the transformation table 128, the host data 126, and the configuration data 132 are updated with information. The updates may include information about the data sources 104, host parameters associated with the data sources 104, and procedures for transformation of data from one data presentation to another. In one implementation, the update may occur after expiration of a pre-defined time period. In another implementation, the update may also be initiated by the communication module 118 when the data received cannot be transformed from one data presentation to another data presentation. In one example, the DSCD 102 may not be able to transform the data either due to unavailable value for host parameters included in the data, or due to unavailable procedure to complete such transformation. If the values of host parameters included in the data are unavailable with the DSCD 102, the communication module 118 may initiate an update of the data 116 such that the data presentation table 130 and/or the host data 126 is updated. Similarly, if it is identified by the DSCD 102 that a procedure for transformation of the data from one data presentation to another data presentation is not available in the transformation table 128, the communication module 118 may initiate the update of the data 116 to receive a procedure to support the transformation.

In certain situations, there may be an addition of new data sources 104 that operate using a data presentation unknown to the DSCD 102. In such situations, based on the data received, the analysis module 120 may not be able to identify the specific data source 104. Therefore, the communication module 118 may update the data 116 such that the information necessitated to communicate with the new data sources 104 is available.

In an illustrative example, the implementation of a DSCD 102 is now described. In such an example, the DSCD 102 may store data of multiple health systems located at different geographic locations and operating on different data presentations. The health systems may have different data layouts and different data formats. For instance, one health system may operate using a big endian data format while the DSCD 102 may operate using a little endian data format. Similarly, some health systems may process data in relational database structure, while the DSCD 102 may store data as HBase files. Further, one health system may understand data in ‘Hindi’ language while another in ‘Mandarin’ Therefore, in such situations, any data received from the health systems by the DSCD 102 may be analyzed. Based on the analysis, the data presentation of the data may be determined. In case the DSCD 102 is able to identify the data presentation of the data received, the DSCD 102 may transform the data according to any suitable processing. However, in situations when the DSCD 102 is not able to identify either the data presentation of the data received, or a corresponding procedure for transformation, the DSCD 102 may update the data 116 for corresponding entries of health systems and corresponding data presentations.

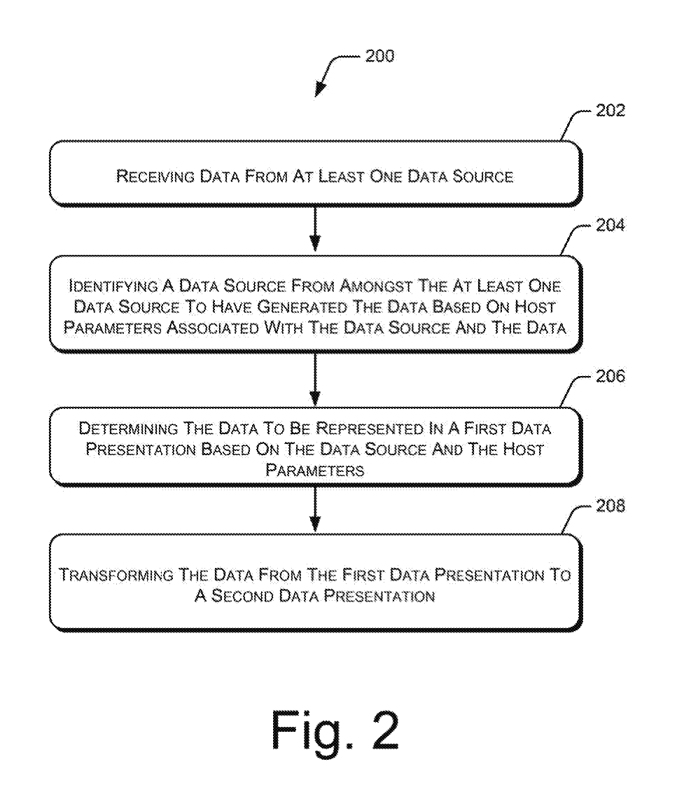

FIG. 2 illustrates a method 200 for communication in a heterogeneous distributed system, according to an implementation of the present subject matter. The order in which the method 200 is described is not intended to be construed as a limitation, and any number of the described method blocks may be combined in any order to implement the method 200, or an alternative method. Furthermore, the method 200 may be implemented by processor(s) or computing device(s) through any suitable hardware, non-transitory machine readable instructions, or combination thereof.

It may be understood that steps of the method 200 may be performed by programmed computing devices. The steps of the methods 200 may be executed based on instructions stored in a non-transitory computer readable medium, as will be readily understood. The non-transitory computer readable medium may include, for example, digital memories, magnetic storage media, such as one or more magnetic disks and magnetic tapes, hard drives, or optically readable digital data storage media.

Further, although the method 200 may be implemented in a variety of computing devices of the heterogeneous distributed system; in an embodiment described in FIG. 2, the method 200 is explained in context of the aforementioned data source computing device 102, for ease of explanation.

Referring to FIG. 2, in an implementation of the present subject matter, at block 202, data from at least one data source may be received. In one implementation, the at least one data source may operate using different data presentations and may be located at different geographic locations.

At block 204, a data source from amongst the at least one data source is identified to have generated the data. The identification may be based on host parameters associated with the data source and the data. The host parameters may include, but are not limited to, Media Access Control (MAC) address, an Internet Protocol (IP) address, an application Identifier, a pre-defined label, a data source Identifier, and a data pattern. In one implementation, the data source may include values, for host parameters, such as pre-defined label in the data.

At block 206, the data is determined to be represented in a first data presentation based on the data source and the host parameters. The data presentation of the data received may either be determined based on the data source, or may be based on the analysis of the data itself. For example, upon identification of the data source, it may be determined based on data presentation table that the data source operates using the first data presentation. Similarly, for the data received, based on the values of some of the host parameters, such as pre-defined label and data pattern, the data presentation may be directly determined to be the first data presentation.

At block 208, the data is transformed from the first data presentation to a second data presentation. In one implementation, the transformation of the data generates a transformed data that is utilized further. The transformation may be based on transformation table that may define a pre-defined procedure to transform the data from one data presentation to another.

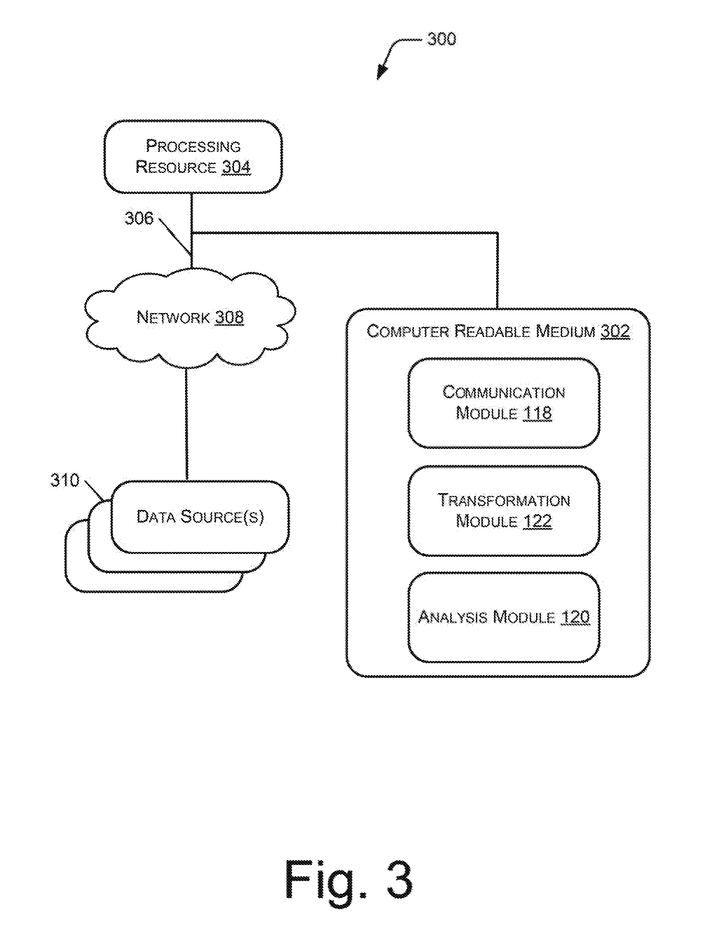

FIG. 3 illustrates a heterogeneous distributed system 300 implementing a non-transitory computer-readable medium 302, according to an implementation of the present subject matter. In one implementation, the non-transitory computer readable medium 302 may be utilized by a computing device, such as the DSCD 102 (not shown). The DSCD 102 may be implemented in a public networking environment or a private networking environment. In one implementation, the heterogeneous distributed system 300 includes a processing resource 304 communicatively coupled to the non-transitory computer readable medium 302 through a communication link 306.

For example, the processing resource 304 may be implemented in a computing device, such as the DSCD 102 described earlier. The computer readable medium 302 may be, for example, an internal memory device or an external memory device. In one implementation, the communication link 306 may be a direct communication link, such as any memory read/write interface. In another implementation, the communication link 306 may be an indirect communication link, such as a network interface. In such a case, the processing device 304 may access the computer readable medium 302 through a network 308. The network 308 may be a single network or a combination of multiple networks and may use a variety of different communication protocols.

The processing resource 304 and the computer readable medium 302 may also be communicating with data sources 310 over the network 308. The data sources 310 may include, for example, desktop computers, laptops, smart phones, PDAs, and tablets. The data sources 310 have applications that communicate with the processing resource 304, in accordance with the present subject matter.

In one implementation, the computer readable medium 302 includes a set of computer readable instructions, such as the communication module 118, the transformation module 122, and the analysis module 120. The set of computer readable instructions may be accessed by the processing resource 304 through the communication link 306 and subsequently executed to process data communicated with the data sources 310.

For example, the communication module 118 may receive and provide data to the data sources 310. The data sources 310 of the heterogeneous distributed system may operate using different data presentations.

For any data received from the computing device, the analysis module 120 may determine specific data sources 310 to have generated the data. The determination may be based on host parameters which may include, but are not limited to, Media Access Control (MAC) address, an Internet Protocol (IP) address, an application Identifier, a pre-defined label, a data source Identifier, and a data pattern.

Values for some of the host parameters may be inherent in the data received, such as IP address of the data sources 310 and MAC address of the data sources 310. However, in certain situations, the data sources 310 may not be identifiable based merely on such inherent parameters. Therefore, the analysis module 120 may also determine the data sources 310 to have generated the data based on values inserted by the data sources 310, in the data. Such values may be inserted for host parameters, such as pre-defined label. In other words, the data sources 310 may include values for the pre-defined label such that the analysis module 120 may identify that the data received was generated by a specific data sources 310. In one implementation, the pre-defined label may also include values to define the data presentation of the data.

The transformation module 122 may allow transformation of the data from one data presentation to another. Therefore, according to the present subject matter, the data received by the communication module 118 may have to be transformed to some other data presentation for processing, In such situations, the transformation module 122 may transform determine a procedure to be adopted for the transformation and, based on the determined procedure, perform the transformation. In an example, the procedure of transformation may be defined in a form of a defined function to be executed.

Further, the transformation module 122 may also transform data which may have to be provided to the data source 310. For instance, the processing resource 304 may process a set of instructions and generate data which is to be provided to one of the data source 310. However, the particular computing device may operate using a data presentation different from the one on which the processing resource 304 operates. Therefore, the transformation module 122, in such situation, may transform the data into a data presentation on which the computing device operates and the communication module 118 may communicate the transformed data to the computing device.

Although implementations of communication in a heterogeneous distributed system have been described in language specific to structural features and/or methods, it is to be understood that the present subject matter is not necessarily limited to the specific features or methods described. Rather, the specific features and methods are disclosed and explained in the context of a few implementations for communication in heterogeneous distributed systems.

What is claimed is:

1. A method for communication in a heterogeneous distributed system, the method comprising:
receiving, by a data store computing device, data from at least one data source;
identifying a first data source from amongst the at least one data source to have generated the data based on host parameters, wherein the host parameters are indicative of at least one of the first data source and the data, and wherein the host parameters comprise at least one of a data pattern corresponding to the data and values for the host parameters provided by the first data source in the data;
determining that the data is represented in a first data presentation based on the identified first data source and the host parameters; and
transforming the data from the first data presentation to a second data presentation, wherein the data store computing device operates using the second data presentation.

2. The method as claimed in claim 1, wherein the first data presentation comprises a pre-defined data format and a pre-defined data layout.

3. The method as claimed in claim 1, wherein determining that the data is represented in the first presentation is further based on a data presentation table comprising an entry for the first data source and the corresponding host parameters.

4. The method as claimed in claim 3, further comprising: updating the data presentation table based on at least one of a determination of a new host computing device and an expiration of a pre-defined time interval.

5. The method as claimed in claim 1, wherein transforming the data is based on a transformation table, comprising at least one of procedures and pointers to the procedures to transform data from one data presentation to another data presentation.

6. The method as claimed in claim 1, further comprising:
obtaining second data, wherein the second data is represented in the second data presentation;
transforming the second data from the second data presentation to a third data presentation to generate a transformed second data based on a transformation table; and
providing the transformed second data represented in the third data presentation to another data source from amongst the at least one data source.

7. A data source computing device (DSCD) for communication in a heterogeneous distributed system, the DSCD comprising:
a processor,
a communication module communicatively coupled with the processor to receive data from at least one data source;
an analysis module communicatively coupled with the processor to determine that the data is represented in a first data presentation based on host parameters, wherein the host parameters comprise at least one of a data pattern corresponding to the data and a value for the host parameters, and wherein the value is provided by a first data source from amongst the at least one data source; and
a transformation module communicatively coupled with the processor to transform the data from the first data presentation to a second data presentation, wherein the DSCD operates using the second data presentation.

8. The DSCD as claimed in claim 7, wherein the analysis module identifies the first data source from amongst the at least one data source to have generated the data based on the host parameters associated with the data source and the data to determine a representation of the data.

9. The DSCD as claimed in claim 7, wherein the transformation module is to transform the data based on a transformation table comprising at least one of procedures and pointers to the procedures to transform data from the first data presentation to the second data presentation.

10. The DSCD as claimed in claim 7, wherein:
the communication module is to obtain second data, wherein the second data is represented in the second data presentation; and
the transformation module transforms the second data from the second data presentation to a third data presentation to generate a transformed second data based on a transformation table.

11. The DSCD as claimed in claim 10, wherein the communication module further provides the transformed second data to another data source from amongst the at least one data source.

12. The DSCD as claimed in claim 7, wherein the host parameters comprise at least one of a Media Access Control (MAC) address, an Internet Protocol (IP) address, an application identifier, a pre-defined label, a data source Identifier, and the data pattern.

13. The DSCD as claimed in claim 12, wherein the pre-defined label is included in the data generated by the data source.

14. The DSCD as claimed in claim 7, wherein the at least one data source comprises at least one of a host computing device, an application of the host computing device, and a virtual host computing device.

15. A non-transitory computer-readable medium comprising instructions for a data source computing device (DSCD) for communicating in a heterogeneous distributed system executable by a processor resource to:
receive data from at least one data source;
determine the data to be represented in a first data presentation based on host parameters, wherein the host parameters comprise at least one of a data pattern corresponding to the data and values for the host parameters provided by the first data source in the data; and
transform the data from the first data presentation to a second data presentation, wherein the DSCD operates using the second data presentation.
